(19) United States
(12) Patent Application Publication
(10) Pub. No.: US 2008/0082680 A1
(43) Pub. Date: Apr. 3, 2008

(54) Method for provisioning of credentials and software images in secure network environments

(76) Inventors: Karanvir Grewal, Hillsboro, OR (US); Vincent Zimmer, Federal Way, WA (US); Hormuzd Khosravi, Portland, OR (US); Alan D. Ross, Shingle Springs, CA (US)

Correspondence Address: INTEL/BLAKELY, 1279 OAKMEAD PARKWAY, SUNNYVALE, CA, 94085-4040, US

(21) Appl. No.: 11/540,352

(22) Filed: Sep. 29, 2006

(51) Int. Cl. G06F 15/16

(52) U.S. Cl. 709/232; 709/200

(57) ABSTRACT

A method of providing a secure download of a boot image to a remote boot environment of a computer system. In one embodiment of the invention, the remote boot environment and a boot image source engage in a boot image exchange through an authentication channel. In another embodiment, data related to the boot image exchange is tunneled in the authentication channel to protect the boot image exchange from security attacks.

### BACKGROUND OF THE INVENTION

1. Field of the Invention

The invention relates generally to providing security for boot image exchanges. More particularly, an embodiment of the invention uses data tunneling to protect a boot image download to a remote boot environment of a computer system.

2. Background Art

Remote booting allows a device, while in a preboot state, to obtain a boot image from an outside server or other source rather than from a local storage media such as a floppy disk, hard drive, or CDROM. Remote booting relies on a preboot protocol which is implemented by a remote boot environment residing on the device. A typical remote boot environment uses basic input/output system (BIOS) firmware instructions to direct an interface such as a network interface card (NIC) to download a boot image which is then run locally to boot up the device. One example of such a remote boot environment is the Preboot Execution Environment (PXE), which is part of the INTEL® Wired for Management specification (version 2.1, published by INTEL® Corporation of Santa Clara, Calif. and SYSTEMSOFT® Corporation of Newton, Mass. on Sep. 20, 1999).

The robustness of PXE includes its ability to conduct a boot image exchange by taking advantage of various network protocols such as Internet Protocol (IP), Dynamic Host Configuration Protocol (DHCP), User Datagram Protocol (UDP) and Trivial File Transfer Protocol (TFTP). However, PXE today offers little more than a set of recommendations on how to use these protocols. For example, the PXE process currently leverages an insecure DHCP to retrieve information about an available PXE server, and subsequently leverages an insecure TFTP session with the PXE server to retrieve the boot image. Moreover, PXE traditionally offers the Boot Integrity Services (BIS) for providing an integrity check of a loaded boot image. BIS is not widely deployed, however, because it relies on user configuration of a Boot Object Authorization Certificate (BOAC).

With the recent gain in momentum for various network access control methods, the native execution of network protocols by the remote boot environment is not viable without some form of network authentication protocol being executed for initial network access. Additionally, leveraging these protocols in a native form presents a number of security vulnerabilities, which may be easily exploited by an adversary to undermine the retrieval of secure credentials or boot images from a network resource.

### BRIEF DESCRIPTION OF THE DRAWINGS

FIG. 1 is a block diagram illustrating a network transferring boot image information to remote boot environments residing on various network nodes.

FIG. 2 is a block diagram illustrating a server farm wherein boot image information is transferred to remote boot environments residing on individual servers.

FIG. 3 is a sequence diagram illustrating a boot image exchange using a remote boot environment.

FIG. 4 is a sequence diagram illustrating a use of a data tunnel to exchange cryptographic information related to a boot image exchange.

FIG. 5 is a sequence diagram illustrating a use of a data tunnel to protect a boot image exchange.

FIG. 6 is a flow diagram illustrating an algorithm for secure boot image exchange by a remote boot environment.

FIG. 7 is a block diagram illustrating a computer wherein a remote boot environment resides.

FIG. 8 is a data structure diagram illustrating information tunneled in a Type-Length-Value (TLV) format.

### DETAILED DESCRIPTION

Techniques and architectures for providing a secure transfer of boot image information are described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions which follow are presented in terms of algorithms and symbolic representations of operations on data bits within a computer memory. These algorithmic descriptions and representations are the means used by those skilled in the networking arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the invention is not described with reference to any particular programming language. It will be appreciated that a variety of programming languages may be used to implement the teachings of the invention as described herein.

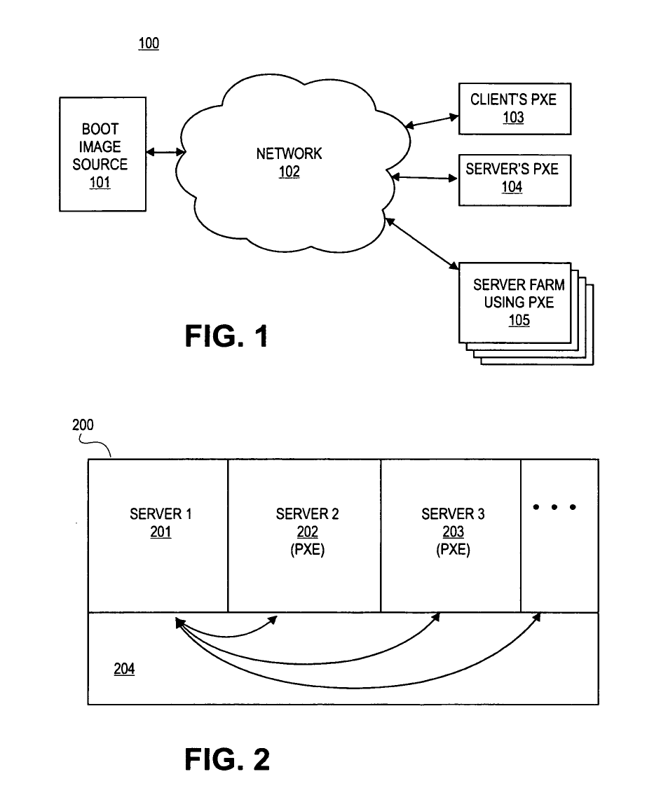

FIG. 1 illustrates one framework in which an embodiment may be practiced. FIG. 1 shows a system 100 wherein a boot image is sent from a boot image source 101 over a network 102 to the remote boot environments of one or more other network nodes. In this example, the other network nodes include a client supporting PXE 103, a single server supporting PXE 104 and a server farm supporting PXE 105. However, any number of boot image sources and any number of network nodes supporting remote boot environments can be used. It is understood that a salient feature of a system or apparatus receiving the boot image is its support of a remote boot environment. It is also understood that, other than PXE, any remote boot environment which supports tunneling data in an authentication channel may be used.

Network 102 provides an interconnection between multiple network nodes, such as client computers, blade servers, server farms, etc. In one embodiment, network 102 is a local area network (LAN) such as those well known in the art. In alternative embodiments, network 102 can be a wide area network (WAN), the Internet, or any other type of network. Boot image source 101 is a server or other device that stores one or more boot images that can be used to the network nodes supported by the boot image source.

These nodes can be, for example, a server 104 or servers 105 controlled by an IT organization such that technicians can download a boot image from the boot image source 101 via network 102 without having to more directly access the receiving nodes. The boot image is understood to include any data used to bring a system out of a preboot state. This data includes, but is not limited to, operating systems, system utilities, diagnostics, data recovery information and similar system software. The boot image may constitute only part of a boot image exchange, which may further include other information exchanged between devices to facilitate the transmission of the boot image from one device to another. The boot image exchange may include, for example, protocol handshaking, the exchange of secure credentials and encryption key exchanges.

FIG. 2 illustrates another framework in which an embodiment may be practiced. FIG. 2 illustrates a server farm 200 wherein a boot image is sent from a first server 201 through a local shared bus 204 to the remote boot environment of one or more servers 202, 203 in the server farm 200. In this example, each of the servers 202, 203 support PXE as a remote boot environment. At some point the first server 201 has an updated version of a boot image, while one or more servers 202, 203 in the server farm 200 are in a preboot state, and require the updated version of the boot image. The communications associated with a boot image exchange between the first server 201 and another server 202 in the server farm may be simpler than that illustrated in FIG. 1. For example, the PXE residing on server 202 may initiate the boot image exchange without needing to acquire an IP address via a DHCP exchange. Identifying the first server 201 as the boot image source may also be more simplified for a server farm, as compared to the discovery of a boot image server in a network. However, the security of a boot image exchange on the local shared bus 204 is contingent upon the integrity of each server in the server farm 200. Therefore, as with the example of a boot image exchange over a network 102, boot image exchange on the shared bus 204 of a server farm 200 are subject to some of the same security risks.

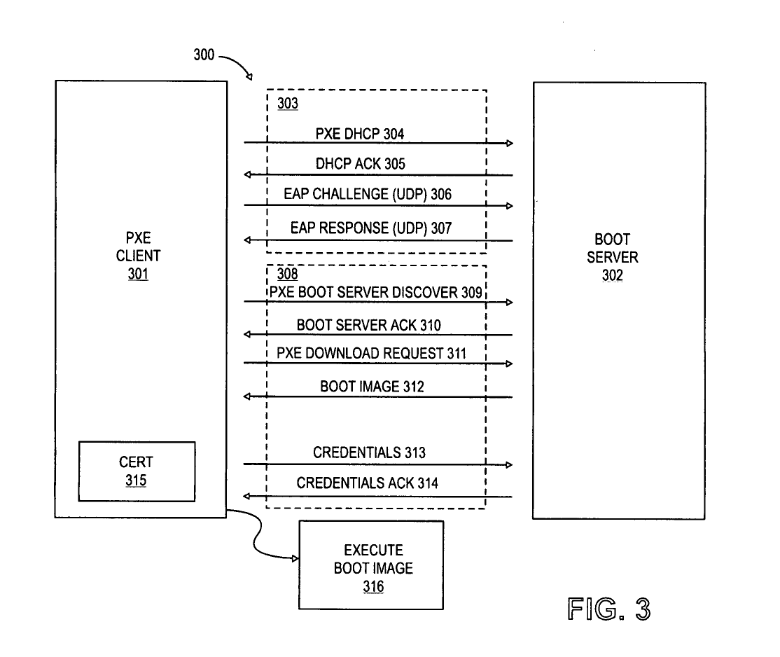

FIG. 3 illustrates a typical exchange 300 involving the remote boot environment of a network node and a boot image source on a network. In this example, the network node is a PXE client 301 which implements PXE as its remote boot environment, and the boot image source is a boot server 302. The exchange 300 includes a first phase 303 to establish of an authentication channel and a second phase 308 to exchange the boot image between the PXE client 301 and the boot server 302 using the established authentication channel.

In the first phase 303, the remote boot environment of the PXE client 301 sends PXE DHCP 304 to discover a DHCP server and request an IP address and IP configuration parameters needed to communicate with the boot server. For simplicity of illustration, in this example, the DHCP server is also the boot server 302. The PXE client 301 receives a DHCP ACK 305 which contains an IP information which the PXE client 301 will use to communicate with the boot server 302.

To authenticate itself in the network in which the boot server 302 resides, the PXE client 301 will provide the network access capabilities appropriate to the network access framework. In networks compliant with the Institute of Electrical and Electronics Engineers (IEEE) 802.1X standard, this is in the form of an 802.1X supplicant, executing an appropriate EAP method for authenticating the client to a Network Access Device (NAD), which may be a switch or an Access Point (AP) (not shown in FIG. 3). In non-802.1X networks, this manifests itself in the EAP protocol being conveyed over a UDP exchange (EAP-UDP). Furthermore, in remote access scenarios, this may be instantiated via a Virtual Private Network (VPN) connection. An example of this last type would be by leveraging an EAP method over an Internet Key Exchange (IKE) version 2 protocol for IPSec based VPNs. An example of such an IKE is set forth in RFC 2409 of the Network Working Group, dated November 1998. In the example illustrated in FIG. 3, the PXE client 301 is authenticated by the exchange EAP CHALLENGE (UDP) 306 and EAP RESPONSE (UDP) 307.

In the second phase 308, once an authentication channel has been established between the PXE client 301 and network on which the boot server 302 resides, the PXE client 301 can initiate a boot image exchange with the boot server 302. It is understood that a boot image exchange includes all communications which aid the transmission of a boot image from a boot image source to a remote boot environment residing on another computing system. This may include any server discovery and handshaking messages for protocols used in the transmission of the boot image.

The PXE client 301 discovers the boot server 302 through the PXE BOOT SERVER DISCOVER 309 and a returned acknowledgement BOOT SERVER ACK 310. Once the boot server is found, the boot image itself can be requested via PXE DOWNLOAD REQUEST 311. Upon receiving the request for the boot image, the boot server 302 sends BOOT IMAGE 312 to the PXE client 301. In addition to the first phase 303 and second phase 308 of the exchange 300, the PXE 301 may have other credentials or certification 315 (other than a BOAC) to send to the boot server 302 via CREDENTIALS 313 and CREDENTIALS ACK 314. Once the boot image is received, the PXE client 301 can boot itself by executing the boot image 316.

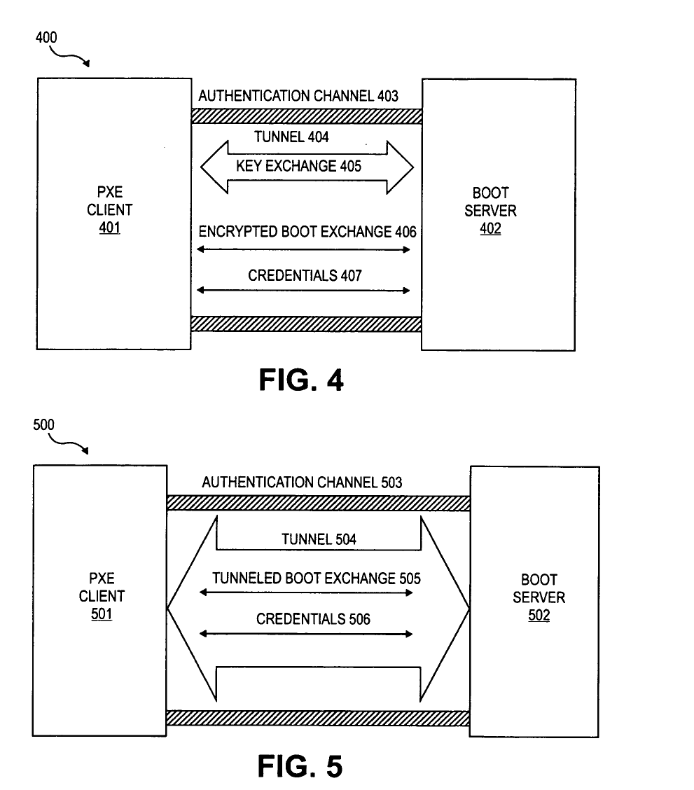

FIG. 4 illustrates an embodiment 400 wherein a secure data transmission is used to protect the boot image exchange. This embodiment 400 provides a means to encapsulate an in-band BIOS/firmware-based flow of a remote boot environment within a stronger security context. An example of such as firmware-based flow is one which is compliant with the Unified Extensible Firmware Interface (UEFI) Specification version 2.0, released by the UEFI forum. Specifically, a generic tunneling method is used to securely providing a boot image to the PXE residing on an apparatus or system through an EAP authentication channel 403. In this context, TLV tunneling and attribute-value pair (AVP) tunneling are both used to describe a generic mechanism to encapsulate any arbitrary data.

FIG. 4 illustrates a secure boot image exchange between the PXE client 401 and the boot server 402 leveraging an established authentication channel 403, represented by dark lines. Within the EAP authentication channel 403, a data tunnel 404 is used to send data related to the boot image exchange. In this case, boot server 402 uses an encrypted boot image exchange 406, and the tunneled data related to the boot image exchange is the exchanged encryption key information 405. Other cryptographic information may be exchanged in lieu of or in addition to the exchanged encryption key information 405. Exchanges of data other than the boot image exchange 406, such as the exchange of credentials 407, may take place outside of the data tunnel 404. The encryption method and keys may comply, for example, with the Advanced Encryption System (AES), recommended by the National Institute of Standards and Technology (NIST), see Federal Information Processing Standards (FIPS) PUB 197, Nov. 26, 2001. Various types of cryptography—e.g. symmetric, asymmetric, public-key, private-key—may be used in varying embodiments, which are not limited in this context. In one embodiment, the keys may encrypt and/or authenticate the boot image by the server. The keys may then be conveyed to the client, which can use these keys to validate the integrity of the boot image. In such a usage model, the authenticated channel may only be used to convey the cryptographic keys and the boot image is transferred outside of the authenticated channel. Validation of the integrity of the boot image by leveraging these cryptographic keys ensures that the boot image is genuine and in the expected form and not sent and/or modified by a malicious entity. Upon completion of the encrypted boot exchange 406 and the tunneled key exchange 404, the PXE client 401 may execute the received boot image from within a resident PXE environment, as discussed above.

FIG. 5 illustrates a secure boot image exchange 500 between the PXE client 501 and the boot server 502 leveraging an established authentication channel 503, represented by dark lines. Within the EAP authentication channel 503, a data tunnel 504 is used to send data related to the boot image exchange. The data tunnel 504 may be of the TLV type, AVP type or compliant with another generic method to pass generic data between two interested parties. In this case, the data related to the boot image exchange which is tunneled is the entire boot exchange itself 505. The credentials 506 are also tunneled in this example. In varying embodiments, less than all of the boot image exchange is tunneled. In still other embodiments, exchanges of data other than the tunneled boot image exchange 505, such as the exchange of credentials 506, may take place outside of the data tunnel 504. Upon completion of the tunneled boot exchange 505 and the exchange of credentials 506, the PXE client 501 may execute the received boot image from within a resident PXE environment, as discussed above.

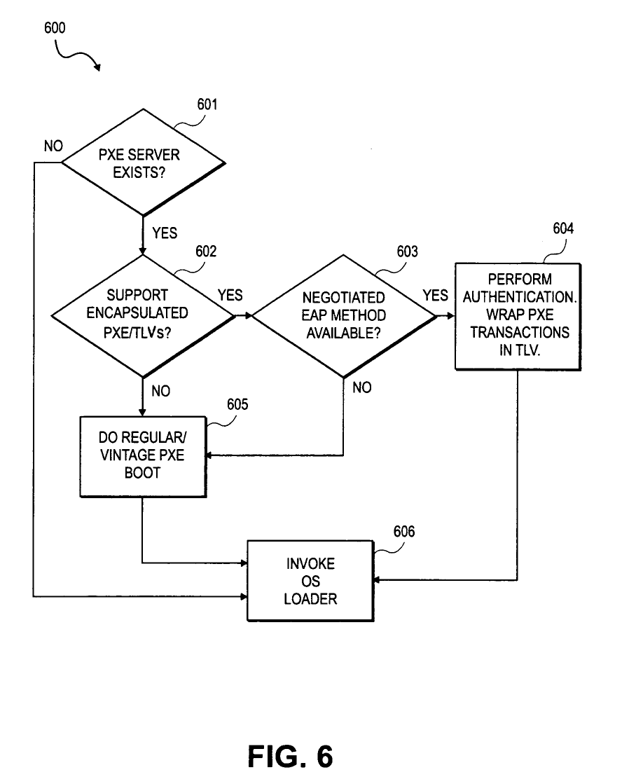

FIG. 6 illustrates an algorithm 600 for a method implementing one embodiment. In this example, the method is performed at the PXE client seeking to acquire a boot image from a boot image source, e.g. a PXE boot server. At 601, the PXE environment residing on the PXE client searches for an existing PXE boot server. This search may include acquiring network access through a DHCP server and sending a PXE boot server discover message, as discussed above. If a PXE boot server is not available, at 606, the PXE client invokes an OS loader of the PXE client which may load an already existing, possibly outdated, boot image. If a PXE boot server is available, at 602, the PXE client looks to see if the PXE supports data tunneling for a boot image exchange, such as the encapsulation of the PXE exchange in TLV/AVP.

If the PXE does not support data tunneling for a boot image exchange, at 605, the PXE client may perform a traditional, i.e. less secure, PXE exchange, or alternatively not allow the device to remote boot at all (not shown) depending on an enforced administrative policy. If the PXE supports data tunneling for a boot image exchange, at 603, the PXE client tries to negotiate an authentication channel method, e.g. a negotiated EAP method, with the PXE boot server. If the negotiation fails, at 605, the PXE client may perform a traditional, i.e. less secure, PXE exchange, or alternatively not allow the device to remote boot at all (not shown™ depending on an enforced administrative policy. After completion of the traditional PXE exchange, at 606, the PXE client invokes an OS loader of the PXE client which may load the boot image received through an insecure exchange.

If the negotiation succeeds, at 604, the PXE client may perform the method to establish an authentication channel, and conduct a boot image exchange in within the authentication channel. As discussed above, data related to the boot image exchange is tunneled between the PXE client and the PXE boot server. In one embodiment, at least part of the boot image is encrypted, and a TLV/AVP data tunnel is used to exchange encryption key information used to decrypt the boot image. In another embodiment, at least part of the boot image itself is exchanged in a TLV/AVP data tunnel. Once the partially-tunneled PXE transaction between the PXE client and the boot server completes, at 606, the PXE client invokes an OS loader of the PXE client which may load the boot image received through a secure, at least partially tunneled, exchange.

The invention also relates to apparatus for performing the operations described herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus. In alternative embodiments, hard-wired circuitry can be used in place of or in combination with software instructions to implement the invention. Thus, the invention is not limited to any specific combination of hardware circuitry and software instructions.

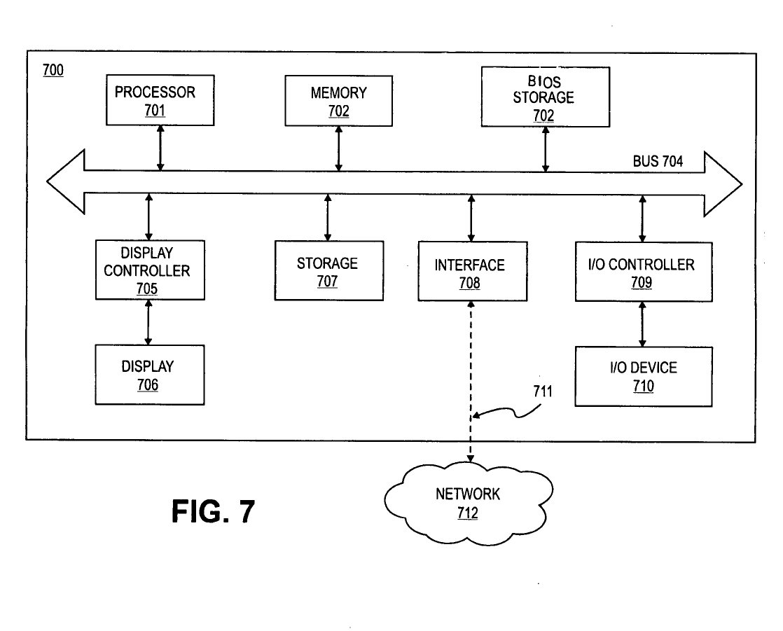

FIG. 7 illustrates one embodiment of a computer system suitable for use in one embodiment. Computer system 700 includes bus 704 or other communication device for communicating information and processor 701 coupled to bus 704 for processing information. While computer system 700 is illustrated with a single processor, computer system 700 can include multiple processors. Computer system 700 further includes a memory device 702 such as random access memory (RAM), coupled to bus 704 for storing information and instructions to be executed by processor 701. Memory 702 also can be used for storing temporary variables or other intermediate information during execution of instructions by processor 701. Computer system 700 also has, coupled to bus 704, non-volatile storage 702—e.g. read-only memory (ROM) or firmware to store BIOS instructions or similar system software for processor 701. Other storage media 707 such as flash memory, a magnetic disk or optical disc and corresponding drive may be further coupled to bus 704 for storing information and instructions.

Computer system 700 can also have a display 706 such as a cathode ray tube (CRT) or liquid crystal display (LCD) coupled to bus 704 via a display controller 705, for displaying information to a computer user. Alphanumeric input/output (I/O) device 710, including alphanumeric and other keys, may also be coupled to bus 704 via an I/O controller 709. Computer system 700 further includes network interface 708 that provides access to a network 712. In one embodiment, network interface 708 is a network interface card (NIC). Network interface 708 is used to download boot images from a remote boot image source server to boot computer system 700 according to one embodiment. The downloaded boot image can be stored, for example, in main memory 104, ROM 106, or other memory device.

One embodiment is related to the use of a data tunnel to securely provide a PXE environment residing on computer system 700 with a boot image. According to one embodiment, an exchange of data with computer system 700 via a data tunnel occurs in response to processor 701 executing sequences of instructions contained in non-volatile storage 702. In alternative embodiments, hard-wired circuitry can be used in place of or in combination with software instructions to implement the invention. Thus, the invention is not limited to any specific combination of hardware circuitry and software instructions.

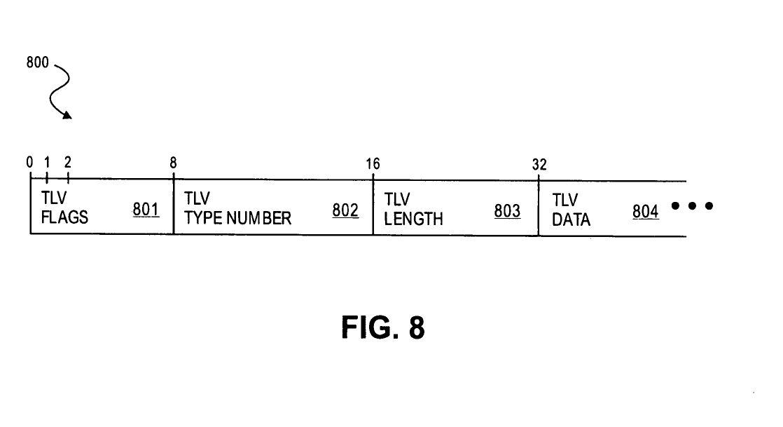

FIG. 8 illustrates the data structure 800 of information tunneled according to a TLV format, as used in one embodiment. Such a TLV implementation might be one which is compliant with the format set forth in Network Access Control Protocol (NACP), S. Thomson (Editor), Cisco Systems, copyright (C) The Internet Society (2005) May 2005. Various TLV methods, AVP methods, or other methods to tunnel generic data for secure transmission between two interested parties may be used.

In this example, an entity such as a boot image source is sending information to another entity such as a PXE client. The information may be sent via an authentication channel such as an EAP channel, as described above. Within the data stream to the PXE client, the boot image source may insert the data structure 800. The data structure 800 begins with a TLV flags field 801 to identify the TLV data structure 800 and, for example, to designate a response in the event the TLV format is not supported by the PXE client. A TLV type number field 802 is used to indicate how information is formatted in the data structure 800. The data structure 800 also includes a TLV length field 803, to indicate a length of data being sent via the data structure 800. The data structure 800 also includes a TLV data filed 804, alternately known as the TLV value field, which represents the actual tunneled data being sent from the boot image source to the PXE client. FIG. 8 represents just one type of data tunneling generally, and one type of TLV tunneling in particular. The exact type of TLV/AVP or other data tunneling used in data exchanges between the boot image source and the PXE client is not limiting on varying embodiments.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
establishing an authentication channel between a first electronic system and a second electronic system;
initiating a remote boot exchange between a remote boot environment of the first electronic system and the second electronic system through the authentication channel, the remote boot exchange including
sending from the remote boot environment of the first electronic system a boot image request, and
sending from the second electronic system to the remote boot environment of the first electronic system a copy of the boot image; and
tunneling data related to the boot image exchange via a data tunnel in the authentication channel.

2. The method of claim 1 wherein the data related to the remote boot exchange comprises at least part of the remote boot exchange.

3. The method of claim 1 wherein at least part of the remote boot exchange is encrypted, and wherein the data related to the remote boot exchange comprises cryptographic information to decipher the remote boot exchange.

4. The method of claim 1, the remote boot environment of the first electronic system compliant with the INTEL™ Pre-boot Execution environment format.

5. The method of claim 1, the authentication channel compliant with the Institute of Electrical and Electronics Engineers (IEEE) 802.1X standard.

6. The method of claim 1 wherein the data tunnel in the authentication channel is an attribute-value pair (AVP) tunnel.

7. The method of claim 1 wherein the data tunnel in the authentication channel is a type-length-value (TLV) tunnel.

8. The method of claim 1 wherein the second electronic system is on a network, the method further comprising:
sending a Dynamic Host Configuration Protocol (DHCP) query from the remote boot environment of the first electronic system to the network; and
sending a DHCP acknowledgment from the network to the remote boot environment of the first electronic system.

9. The method of claim 1, the remote boot exchange further including:
sending from the remote boot environment of the first electronic system to the second electronic system the credentials of the first electronic system; and
sending an acknowledgement of a receipt of credentials from the second electronic system to the remote boot environment of the first electronic system.

10. A method comprising:
establishing an authentication channel;
initiating, via a remote boot environment, a remote boot exchange through the authentication channel, the remote boot exchange including
sending a boot image request,
receiving a copy of the boot image; and
tunneling data related to the boot image exchange via a data tunnel in the authentication channel.

11. The method of claim 10 wherein the data related to the remote boot exchange comprises at least part of the remote boot exchange.

12. The method of claim 10 wherein at least part of the remote boot exchange is encrypted, and wherein the data related to the remote boot exchange comprises encryption information to decipher the remote boot exchange.

13. A method comprising:
establishing an authentication channel with an electronic system;
engaging in a remote boot exchange with a remote boot environment of the electronic system through the authentication channel, the remote boot exchange including
receiving a request for a boot image from the electronic system, and
sending a copy of the boot image to the remote boot environment of the electronic system; and
tunneling data related to the boot image exchange via a data tunnel in the authentication channel.

14. The method of claim 13 wherein the data related to the remote boot exchange comprises at least part of the remote boot exchange.

15. The method of claim 14 wherein at least part of the remote boot exchange is encrypted, and wherein the data related to the remote boot exchange comprises cryptographic information to decipher the remote boot exchange.

16. The method of claim 15 wherein at least part of the remote boot exchange is integrity protected, and wherein the data related to the remote boot exchange further comprises encryption information to decipher the remote boot exchange.

17. An apparatus comprising:
a communications device to establish an authentication channel; and
an operating entity to establish a remote boot environment to engage in a remote boot exchange via the authentication channel, wherein the remote boot environment
sends a request for a boot image, and
receives a copy of the boot image,
the remote boot environment further to tunnel data related to the remote boot exchange via a data tunnel in the authentication channel.

18. The apparatus of claim 17 wherein the data related to the remote boot exchange comprises at least part of the remote boot exchange.

19. The apparatus of claim 17 wherein at least part of the remote boot exchange is encrypted, and wherein the data related to the remote boot exchange comprises encryption information to decipher the remote boot exchange.

20. A system comprising:
a first computer having
a communications device to establish an authentication channel with a computer, and
an entity to create a remote boot environment to engage in a remote boot exchange via the authentication channel, wherein the remote boot environment sends a boot image request and receives from the computer a copy of the boot image, the remote boot environment further to tunnel data related to the remote boot exchange via a data tunnel in the authentication channel;
a second computer to establish an authentication channel with the first computer and establish the remote boot exchange with the first computer through the authentication channel; and
a transmission medium to support the authentication channel between the first and second computers, the transmission medium including a twisted-pair cable.

21. The system of claim 20 wherein the data related to the remote boot exchange comprises at least part of the remote boot exchange.

22. The system of claim 20 wherein at least part of the remote boot exchange is encrypted, and wherein the data related to the remote boot exchange comprises encryption information to decipher the remote boot exchange.

23. A machine-readable medium having stored thereon a set of instructions which when executed cause a system to perform a method comprising:
establishing an authentication channel;
initiating, via a remote boot environment, a remote boot exchange through the authentication channel, the remote boot exchange including
sending a boot image request,
receiving a copy of the boot image; and
tunneling data related to the remote boot exchange via a data tunnel in the authentication channel.

24. The machine-readable medium of claim 23 wherein the data related to the remote boot exchange comprises at least part of the remote boot exchange.

25. The machine-readable medium of claim 23 wherein at least part of the remote boot exchange is encrypted, and wherein the data related to the remote boot exchange comprises encryption information to decipher the remote boot exchange.

26. A machine-readable medium having stored thereon a set of instructions which when executed cause a system to perform a method comprising:
establishing an authentication channel with an electronic system;
engaging in a remote boot exchange with a remote boot environment of the electronic system through the authentication channel, the remote boot exchange including
receiving a request for a boot image from the electronic system, and
sending a copy of the boot image to the remote boot environment of the electronic system; and
tunneling data related to the remote boot exchange via a data tunnel in the authentication channel.

27. The machine-readable medium of claim 26 wherein the data related to the remote boot exchange comprises at least part of the remote boot exchange.

28. The machine-readable medium of claim 26 wherein at least part of the remote boot exchange is encrypted, and wherein the data related to the remote boot exchange comprises encryption information to decipher the remote boot exchange.
